(19) United States
(12) Patent Application Publication
(10) Pub. No.: US 2007/0050815 A1
(43) Pub. Date: Mar. 1, 2007

(54) Method and apparatus providing for a TV programming information

(76) Inventors: Minoru Kaneko, Yokohama (JP); Tomotami Sato, Yokohama (JP); Norikazu Sasaki, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/508,199

(22) Filed: Aug. 23, 2006

(30) Foreign Application Priority Data
Aug. 30, 2005 (JP) 2005-248579

(51) Int. Cl. G06F 13/00; G06F 3/00; H04N 5/445

(52) U.S. Cl. 725/43; 725/39; 725/40; 725/41

(57) ABSTRACT

A program information notifying method suitable for view or selection of video reservation is provided. In the method, a character string of program information is converted into a voice and the voice is output. When an item in specified program information is converted into a voice for reading aloud or when the program information exceeding a display zone is displayed, a letter at the end of the last character string of the program information is replaced with another letter indicative of ‘to be continued’ of the information to partially display the program information, and voice output is carried out by reading aloud all the program information. When a broadcast symbol is included in the program information, the broadcast symbol is removed, or converted into a character string meaning the broadcast symbol, and the character string is vocally output.

### INCORPORATION BY REFERENCE

This application claims priority from Japanese Patent Application JP2005-248579, filed on Aug. 30, 2005, the content of which is hereby incorporated by reference into this application.

### BACKGROUND OF THE INVENTION

The present invention relates to an apparatus for receiving a television broadcast signal or the like or a video recording apparatus, and more particularly to a method for notifying a viewer of information about a broadcast program which the viewer can suitably grasp.

In television broadcast, program information such as a time table for broadcast programs is notified to viewer's receiver apparatus or video recording apparatus through part of broadcast wave or via the Internet. The television broadcast viewer, when wanting to view a desire program, displays the notified program information on the screen view as an electronic program guide, and selects the desired program from the electronic program guide.

Information about each program includes a program identification code, a broadcast station name, broadcast start time, a broadcast end time, a program name, and a program contents. More specifically, the program contents includes a program category, a program summary, and a performer. In the video recording apparatus such as a recorder, in particular; the viewer, on the basis of programs in the electronic program guide, selects a desired program and sets the apparatus in a reserve-record mode to reserve-record the program.

For the purpose of enhancing the program selection operability based on the electronic programs, JP-A-2000-125221 is proposed as an example. In the publication of JP-A-2000-125221, more specifically, in order for a viewer to easily select a desired program from an electronic program guide, there is disclosed a technique wherein, when the viewer selects the desired program using a remote controller or the like as a means for operating the electronic program guide, this causes the contents of the selected program to appear on the screen view at a given position as a popup, and the appeared program contents to be directly reproduced as a voice.

### SUMMARY OF THE INVENTION

A receiver apparatus such as a television set or a recording apparatus such as a recorder requires a character of an electronic program guide or the like displayed on the screen view to have a certain size, because a viewer operates the apparatus from a remote position using a remote controller or the like. For this reason, the quantity of information capable of being displayed on the screen view is limited. In the technique of the aforementioned prior art, the program contents is displayed as a popup. However, the above technique has a problem that, since the display of the program contents is attained only by user's operation, it is difficult for the user to grasp the program summary.

Some of character strings in program information are compressed (in other words, the amount of information can be increased), and some thereof use an abbreviated symbol indicative of contents of a program or voice (which symbol will be referred to as broadcast symbol, hereinafter) in order to increase a video information visibility. The aforementioned prior art has another problem that, since the broadcast symbol is also read aloud as it is, it is difficult for the user to understand the meaning of the contents of the symbol or hardly to listen to it.

It is therefore an object of the present invention to provide a method for notifying a user of program information which can solve the problems in the prior art and enables a viewer to easily select a program.

The above object is attained by providing a method for notifying a user of program information in an electronic program guide including a broadcast time, broadcast station name, a program name, and a program contents for a TV broadcast program. The program notifying method has a character-string display step of displaying a character string of the program information on a screen view in a predetermined zone, and an information voice output step of converting the character string of the program information to a voice and outputting the voice.

More specifically, in the information voice output step, a character string of the program information having specified any of the broadcast time, broadcast station name, program name, and program contents is converted to a voice and then output. Or in the character string display step, when the number of characters in the program information to be displayed exceeds the amount of characters allowed to the zone, a character indicating the fact that the program information exceeds the zone is placed in the last line of character strings displayed in the zone. And in the information voice output step, even when the number of characters in the program information exceeds the character number allowed to the zone, a selected character string in the program information is converted to a voice and then the voice is output.

In the information voice output step, further, a broadcast symbol included in the program information is removed and then the remaining information is reproduced as a voice; or the broadcast symbol is converted to a character string meaning the broadcast symbol and then the resultant information is output as a voice.

In accordance with the present invention, when a user wants to view or reserve-record a broadcast program, the user can easily grasp the summary of the broadcast program, thus advantageously increasing a program selection operability.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining a function of reading aloud program information in an embodiment of the present invention;

FIG. 2 is a flowchart for explaining a rule of converting a broadcast symbol in the embodiment of the present invention;

FIG. 3 is a table for explaining an example of broadcast symbols in the embodiment of the present invention;

FIG. 4 is a diagram for explaining how to set a control object to be read aloud in the embodiment of the present invention;

FIGS. 5A and 5B show display examples of an electronic program guide in the embodiment of the present invention; and

FIG. 6 is a status transition diagram of a reading-aloud process in a program selection mode in the embodiment of the present invention.

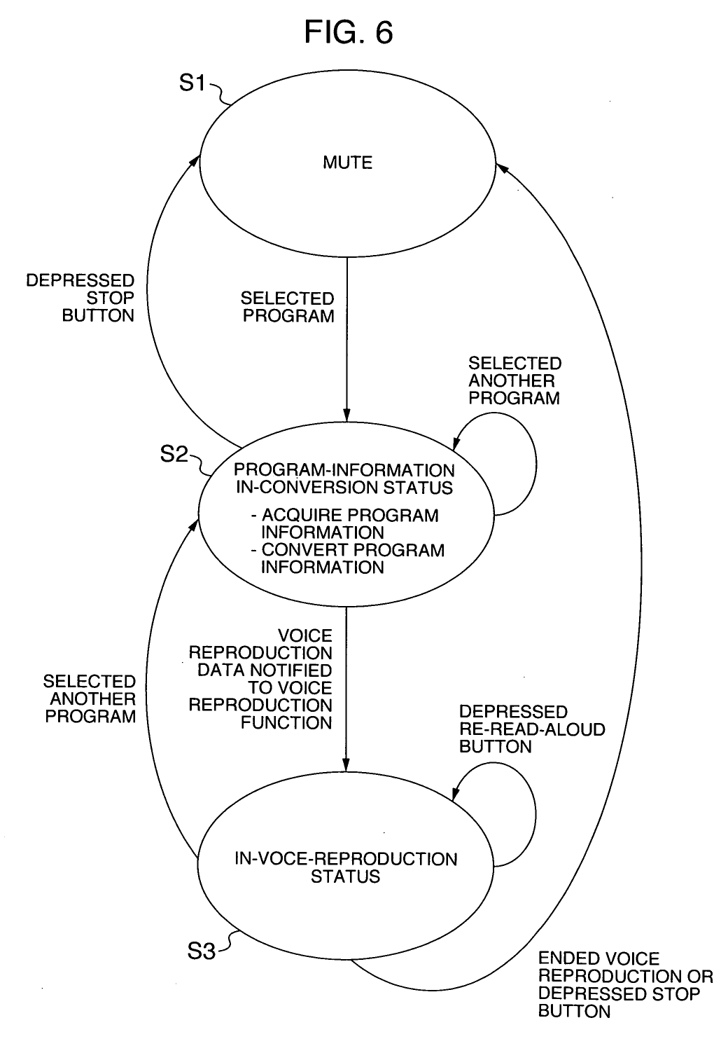

### DESCRIPTION OF THE EMBODIMENTS

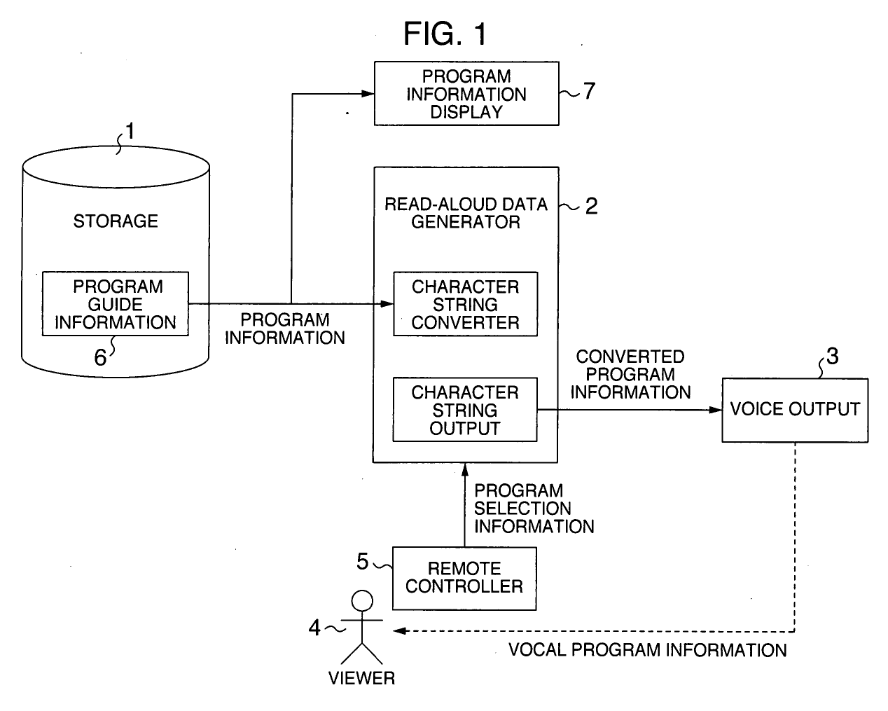

An embodiment of the present invention will be explained with reference to FIG. 1. The figure is a functional block diagram of an embodiment wherein electronic program guide information 6 is displayed on a screen view for a viewer 4 or is notified to the viewer by voice.

The electronic program guide information 6 is transmitted on a broadcast wave or through the Internet to a storage 1 of a receiver apparatus or of a video recording apparatus (not shown) to be recorded therein. The viewer 4 performs operation, for example, to display the electronic program guide with use of a remote controller 5.

For the display of the electronic program guide, program information is read aloud from the electronic program guide information 6 on a program-by-program basis and then displayed on a program information display unit 7 in such a manner as to be listed in a paper column of radios/televisions. At this time, information on a program selected by the user using the remote controller 5 is converted by a read-aloud data generator 2 according to a predetermined conversion rule and is output from the read-aloud data generator 2 as a character string for voice reproduction. The program information converted for voice reproduction is transmitted to a voice output unit 3, where the program information is reproduced as a voice and the voice is read aloud for the viewer 4.

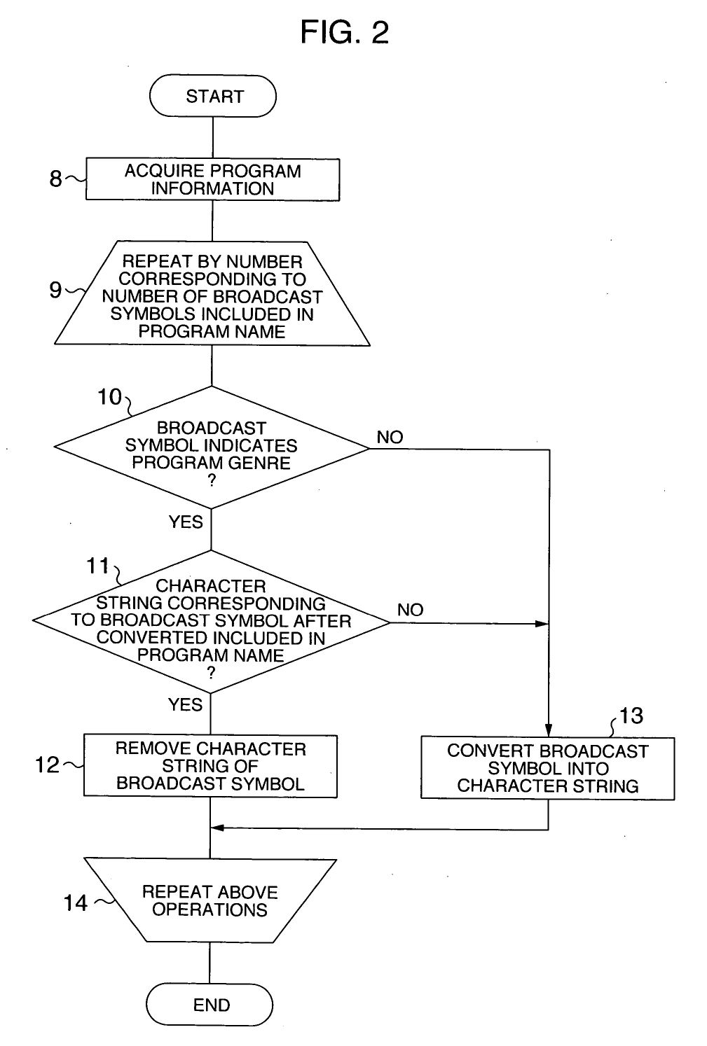

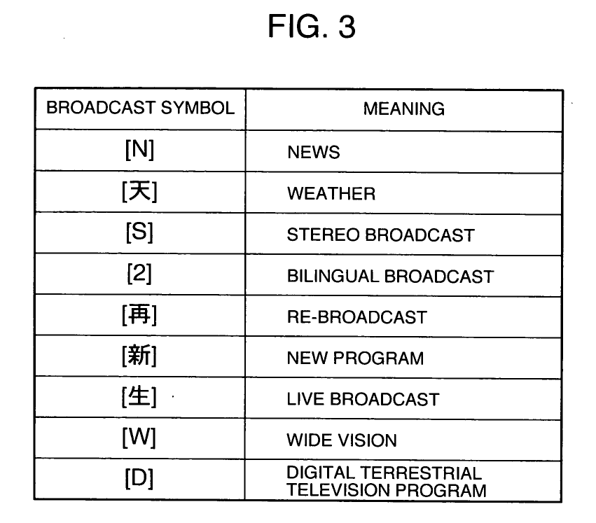

Next, explanation will be made as to an example of a rule of converting a broadcast symbol included in the program information by referring to FIG. 2. Prior to the explanation, an example of broadcast symbols as objects to be converted is shown in FIG. 3.

A column given in the left side of FIG. 3 shows an example of representations of broadcast symbols included in the program information; and a column given in the right side of FIG. 3 shows the meanings of the corresponding broadcast symbols. The broadcast symbols include a symbol relating to a program type such as “N” or [symbol] a symbol indicative of information about a broadcast signal not relating to program contents such as “S”, “2”, “W” or “D”, and a symbol relating to the contents of a broadcast service such as [symbol] or [symbol] Of these broadcast symbols, the symbol relating to the program type such as “N” or [symbol] is information necessary for viewer's view judgment or reservation judgment, and this symbol is a target to be read aloud. The broadcast signal such as “S”, “2”, “W”, or “D” is information not to be read aloud. Further, the symbol relating to the contents of a broadcast service such as [symbol] or “ [symbol] is information, in some cases, necessary for viewer's view judgment or reservation judgment. These broadcast symbols are converted according to a conversion rule to be next explained, and then read aloud.

FIG. 2 shows a processing flow when information on one program is read aloud. The apparatus first acquires program information from electronic program information on a broadcast-program-by-broadcast-program basis (Step 8). The apparatus next searches the program information to know whether or not a broadcast symbol is included in the program name of the program information. For the included broadcast symbol; Steps 10, 11, 12, and 13 are repeated (Step 9).

In the repetitive operations of the above steps, the apparatus first determines whether or not the target broadcast symbol indicates a program type (program genre) (Step 10). When the broadcast symbol does not indicate the program genre (other than “N” or [symbol] the broadcast symbol is converted to a character string corresponding to the meaning of the broadcast symbol as shown in FIG. 3 (Step 13). For example, the broadcast symbol [symbol] is changed to “rebroadcast”, and the broadcast symbol [symbol] is changed to “new program”. At this time, though not shown, since “S”, “2”, “W”, or “D” is not required to be read aloud, the apparatus removes such a broadcast symbol from the program information and reads aloud the remaining character strings in the information.

When the broadcast symbol indicates a program type (genre) in Step 10, the apparatus examines whether or not a character string having the meaning of such a broadcast symbol as shown in FIG. 3 is included in the program name of the program information (Step 11). When such a character string is not included, the apparatus converts the broadcast symbol to a character string corresponding to the meaning of the broadcast symbol (Step 13). When such character string is included, the apparatus removes the broadcast symbol from the program information to obtain a remaining character string to be read aloud (Step 12). The operations of above Steps 10 to 13 are repeated by a number of times corresponding to the number of broadcast symbols included in the program name (Step 14).

Through the above steps, the broadcast symbol in the program information is converted to acquire a read-aloud character string, and the character string is reproduced as a voice by the voice output unit. Through such operations, the broadcast symbols other than the program genre are read aloud, and when a character string corresponding to the program genre is included in the program name, the broadcast symbol is not read aloud. Thus the program information can be read aloud. Therefore, the user can smoothly listen to the program information.

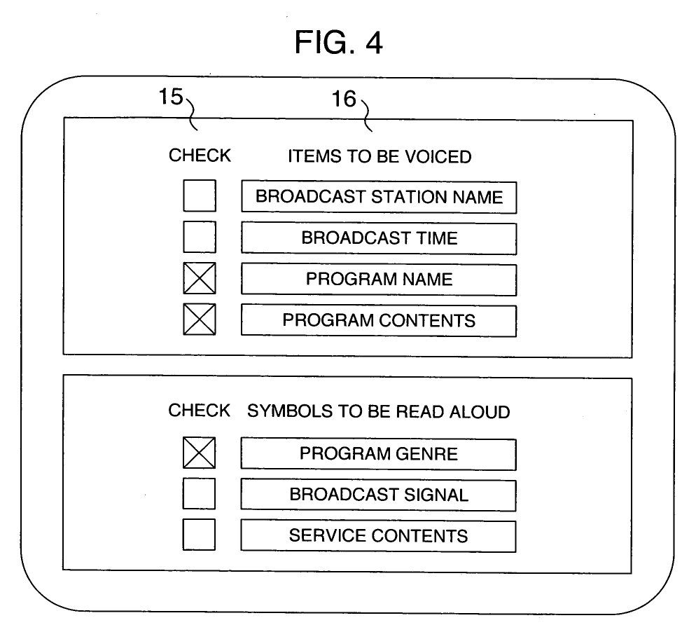

Explanation will next be made as to how to set program information or a broadcast symbol to be read aloud by referring to FIG. 4. The drawing shows a setting screen view for setting voice reproduction by applying such a broadcast symbol conversion rule as explained in FIG. 2 to information about any of the broadcast station name, broadcast time, program name, and program contents for program information. For a left-side check item 15, only checked one or ones of check boxes are voice-reproduced. Check box or boxes not checked are not read aloud. The lower part of FIG. 4 shows a screen view for setting the type of a broadcast symbol to which the conversion rule is to be applied. The conversion rule explained in FIG. 2 has been explained in connection with the case where check blocks are checked as shown in FIG. 4.

It is assumed in FIG. 4 that broadcast symbols for a broadcast signal and for a service contents use such a conversion rule as to read aloud them depending on presence or absence of a check. When these broadcast symbols are not checked as shown in FIG. 4, a broadcast symbol included in character strings of the program name and program contents will not be read aloud.

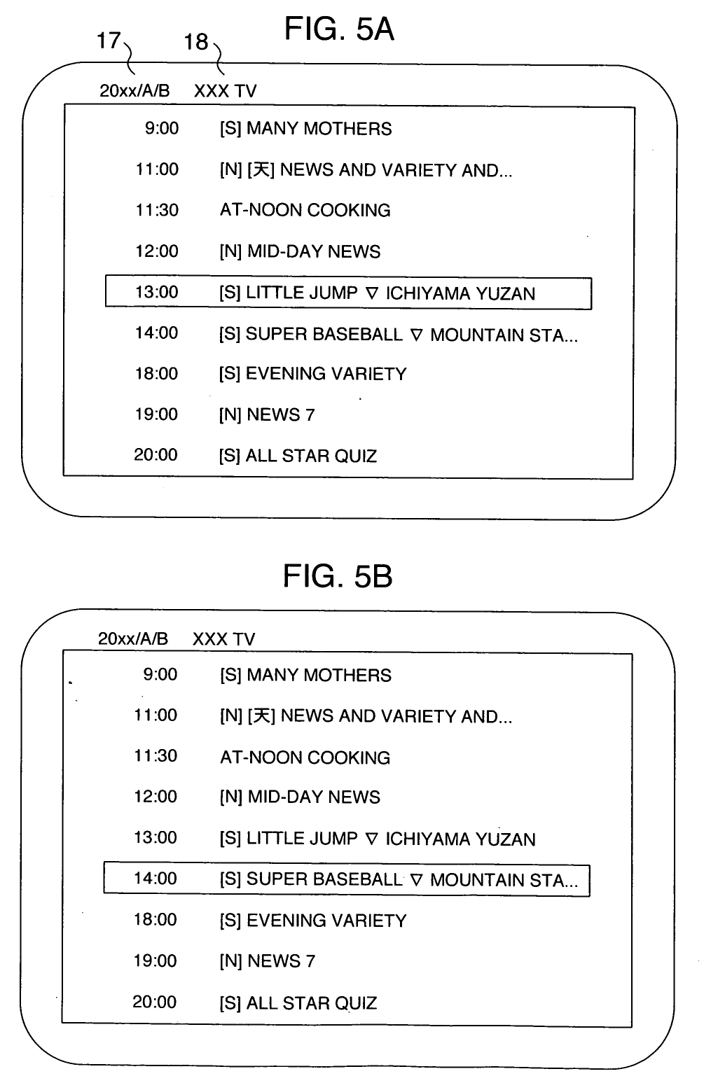

The display contents of the electronic program guide in the embodiment will be then explained by referring to FIGS. 5A and 5B.

The electronic program guide is given as a table. As shown in the screen view of FIG. 5A, a date (year, month, day) 17 and a broadcast station 18 for program information are displayed in the upper part of the screen view. The program information of the broadcast station 18 for the date 17 includes broadcast start times and corresponding programs. In this example, each program includes a broadcast symbol, a program name, a program performer, and a program contents. A display zone size for each of items of the electronic program guide is previously determined. When the display zone is overflowed with the contents of program information, a symbol “ . . . ” is given at the end of the last character string. This indicates that all the program information cannot be displayed in the determined zone.

In the example of FIG. 5A, a program “Little Jump” at 13:00 is selected. If the viewer selects a program “Super Baseball” at 14:00 with use of an operating device such as a remote controller, then such a screen view as shown in FIG. 5B appears. At this time, the read-aloud data generator 2 generates a character string for reading aloud from the program information according to the reading-aloud set items of FIG. 4. In FIG. 5B, the last part of the display of the program information has the symbol “ . . . ” which means that all the program information cannot be displayed on the screen zone. However, program information to be read aloud is “Super Baseball, Mountain Stadium”, and thus even the program information not fully displayed in the electronic program guide can also be reproduced as a voice. Further, the broadcast symbol “S” is not read aloud according to the settings of FIG. 4.

Next the operation of the apparatus when the program information of FIGS. 5A and 5B in the electronic program guide is selected will be explained in detail with use of a status transition diagram of FIG. 7. An initial status is a mute status S1 in which no voice is reproduced. When the user selects a program in the mute status S1, the status is changed to a program-information in-conversion status S2. In this status, information on a program selected by the control function is acquired from the storage, and the acquired information is converted according to the conversion rule. When the user selects another program in the program-information in-conversion status S2, the apparatus interrupts the converting operation, transits again to the same program-information in-conversion status S2, and converts information about the newly-selected program. When the user depresses a stop button on the remote controller in the program-information in-conversion status S2, the apparatus interrupts the converting operation and transits to the mute status S1.

When the apparatus completes the converting operation in the program-information in-conversion status S2, the apparatus transmits the converted program information to the voice reproduction function, transits to an in-voce-reproduction status S3, and voice-reproduces the program information received by the voice reproduction function as it is.

When the user selects another program in the in-voce-reproduction status S3, the apparatus stops the voice reproduction of the program information, and transits to the program-information in-conversion status S2. When the user depresses the stop button in the in-voce-reproduction status S3, the apparatus stops the voice reproduction of the program information, and transits to the mute status S1. When the apparatus completes the voice reproduction of the program information in the in-voce-reproduction status S3, the apparatus transits to the mute status S1. When the user depresses a re-read button on the remote controller in the in-voce-reproduction status S3, the apparatus stops the voice reproduction, instructs the voice reproduction function to start the voice reproduction of the selected program information from the beginning, and transits again to the in-voce-reproduction status.

It should be further understood by those skilled in the art that although the foregoing description has been made on embodiments of the invention, the invention is not limited thereto and various changes and modifications may be made without departing from the spirit of the invention and the scope of the appended claims.

1. A method for notifying of information about television broadcast program, comprising the steps of:
displaying a character string of program information including a broadcast time, a broadcast station name, a program name, and a program contents on a display screen view in a predetermined zone; and
converting a character string of specified any of the broadcast time, broadcast station name, program name, and program contents in said program information into a voice and outputting the voice.

2. The program information notifying method according to claim 1, comprising the steps of:
when the character string of said program information exceeds the predetermined zone of said screen view, converting a letter at a tail of a character string to be displayed into a letter indicative of ‘to be continued’ of the program information and displaying the ‘to be continued’ letter; and
when the character string of said program information exceeds the predetermined zone of said screen view, reading aloud even a character string of said program information exceeding the predetermined zone of said screen view.

3. The program information notifying method according to claim 1, wherein said program information includes a broadcast symbol indicative of a program category such as news or weather forecast, a broadcast symbol indicative of a broadcast type such as stereo broadcast, or a broadcast symbol indicative of a service type such as rebroadcast, new program, or live broadcast, and
said method comprises:
a step of converting a character string of the program information into a voice and outputting the voice except for said broadcast symbol indicative of the broadcast type.

4. The program information notifying method according to claim 1, wherein said program information includes a broadcast symbol indicative of a program category such as news or weather forecast, a broadcast symbol indicative of a broadcast type such as stereo broadcast, or a broadcast symbol indicative of a service type such as rebroadcast, new program, or live broadcast, and
said method comprises the steps of:
converting a broadcast symbol indicative of a program category or a broadcast symbol indicative of a service type in a character string of the program information into a respective predetermined character string; and
converting said converted character string of said broadcast symbol in the program information into a voice and outputting the voice.

5. The program information notifying method according to claim 1, wherein said program information includes a broadcast symbol indicative of a program category such as news or weather forecast, a broadcast symbol indicative of a broadcast type such as stereo broadcast, or a broadcast symbol indicative of a service type such as re-broadcast or new program, and
said method comprises the steps of:
determining whether or not said broadcast symbol indicative of the program category is included in a character string of said program information and a character string corresponding to said broadcast symbol is included in the character string of the program information;
removing said broadcast symbol from the character string of said program information on a basis of a result of said determining step; and
converting the character string of said program information having the character string of said broadcast symbol removed therefrom into a voice and outputting the voice.

6. The program information notifying method according to claim 1, wherein a character string of program information is displayed and the program information is read aloud when the program information is selected and instructed, and the program information is read aloud from the beginning when a re-reading-aloud is instructed through operation of a remote control during reading-loud of the program information.

7. A video recording apparatus comprising:
a program information storage for storing program information of a television broadcast program including a broadcast time, a program name, and a program contents;
a program information display unit for displaying said program information specified in a predetermined zone on a display screen view;
a read-aloud data generator for converting a character string of the program information specified by any of the broadcast time, broadcast station name, program name, and program contents in said program information into voice information; and
a voice output unit for outputting said voice information.

8. The video recording apparatus according to claim 7, wherein, when the character string of said program information exceeds the predetermined zone of said screen view, said program information display unit converts a letter at an end of a character string to be displayed into another letter indicative of ‘to be continued’ of the program information and displays the continuation letter; and, when the character string of said program information exceeds the predetermined zone of said screen view, said read-aloud data generator converts even the character string of said program information exceeding the predetermined zone of said display screen into voice information.

9. The video recording apparatus according to claim 7, wherein said program information includes a broadcast symbol indicative of a program category such as news or weather forecast, a broadcast symbol indicative a broadcast type such as stereo broadcast, or a broadcast symbol indicative of a service type such as re-broadcast, new program, or live broadcast; and said read-aloud data generator converts the character string of the program information having said broadcast symbol of the broadcast type removed from the character string of the program information into voice information.

10. The video recording apparatus according to claim 7, wherein said program information includes a broadcast symbol indicative of a program category such as news or weather forecast, a broadcast symbol indicative a broadcast type such as stereo broadcast, or a broadcast symbol indicative of a service type such as re-broadcast, new program, or live broadcast; said read-aloud data generator converts a broadcast symbol indicated of a program category such as news or weather broadcast, a broadcast symbol indicative of a broadcast type such as stereo broadcast, or a broadcast symbol indicative of a service type such as re-broadcast, new program, or live broadcast to a predetermined character string; said read-aloud data generator converts said broadcast symbol indicative of the program category of the character string of said program information or said broadcast symbol indicative of the service type into a respective predetermined character string; and said voice output unit converts the character string of the program information having said broadcast symbol converted to the predetermined character string into a voice and outputs the voice.

11. The video recording apparatus according to claim 7, wherein said program information includes a broadcast symbol indicative of a program category such as news or weather forecast, a broadcast symbol indicative of a broadcast type such as stereo broadcast, or a broadcast symbol indicative of a service type such as re-broadcast, new program, or live broadcast; said read-aloud data generator determines whether or not said broadcast symbol indicative of the program category is included in the character string of said program information and a character string corresponding to the broadcast symbol is included in the character string of said program information, and removes said broadcast symbol from the character string of said program information; and said voice output unit converts the character string of the program information having the character string of said broadcast symbol removed into a voice and outputs the voice.

12. The video recording apparatus according to claim 7, further comprising a remote controller, when a program is selected and instructed through said remote controller, for causing display of a character string of the program information and reading-aloud of the program information, and when re-reading-aloud is instructed during reading-aloud of the selected program information through the remote controller, for causing reading-aloud of the character string of the program information from the beginning.
